(19) United States
(12) Patent Application Publication
(10) Pub. No.: US 2008/0293263 A1
(43) Pub. Date: Nov. 27, 2008

(54) CONTACT MADE OF CERAMIC AND ITS MANUFACTURING METHOD

(75) Inventor: Shinji Murata, Fukushima-ken (JP)

Correspondence Address: Beyer Law Group LLP, P.O. BOX 1687, Cupertino, CA, 95015-1687, US

(73) Assignee: ALPS ELECTRIC CO., LTD., Tokyo (JP)

(21) Appl. No.: 12/034,605

(22) Filed: Feb. 20, 2008

(30) Foreign Application Priority Data
Mar. 7, 2007 (JP) 2007-057088

(51) Int. Cl. H01R 12/22; H01R 43/16

(52) U.S. Cl. 439/66; 29/874

(57) ABSTRACT

A contact of the invention includes a spring portion and a conductive portion. The spring portion is formed on the surface of a wiring substrate of a probe card, using ceramic. The conductive portion is formed thinly so as to cover at least the surface of the spring portion that faces the bump. Thus, as one of the features of a manufacturing method of the contact, the spring portion is formed at room temperature by an aerosol deposition method.

This application claims benefit of Japanese Patent Application No. 2007-057088 filed on Mar. 7, 2007, which is hereby incorporated by reference.

### BACKGROUND

1. Field of the Invention

The present invention relates to a contact and its manufacturing method, and specifically, to a contact and its manufacturing method that can be suitably utilized in order to manufacture a spring-type probe (contact) of a probe card that performs electrical connection with a semiconductor device that has a bump (projection electrode) formed in the shape of a ball or land.

2. Description of the Related Art

Generally, in a manufacturing process of a semiconductor device, such as IC (Integrated Circuit) or LSI (Large Scale Integration: IC whose degree of integration of elements is 1000 pieces to 10000 pieces), the vain effort of assembling a poor semiconductor device into a package is reduced by connecting a manufactured semiconductor device to a wiring substrate to be tested called a probe card, and by testing input/output of an electric signal with respect to the semiconductor device.

In a probe card that tests a BGA-type (Ball Grid Array: ball-like lattice electrode) or LGA-type (Land Grid Array: land-like lattice electrode) semiconductor device, conical spiral contacts whose centers become apexes and that have an external diameter of several tens of micrometers are formed at narrow pitches of several tens of micrometers in order to be brought into contact with a number of ball-like bumps that are formed at narrow pitches of several tens of micrometers and have an external diameter of several tens of micrometers or with a number of land-like bumps that are formed at narrow pitches of several tens of micrometers and have a width of several tens of micrometers.

The conventional contact 101 is manufactured through three main steps as shown in FIG. 9. In a first step, as shown in FIG. 9A, a seed film 104 and a resist film 123 are formed on the surface of a convex stripe 122 (hereinafter referred to as “resist cone”) that is formed in a conical shape by patterning a flat resist film. Then, by patterning a conical spiral groove 123a in the resist film 123, the seed film 104 is exposed from a conical spiral groove 123a.

In a second step, as shown in FIG. 9B, by plating the seed film 104 exposed from the conical spiral groove 123a using an Ni—P alloy, the spiral groove 123a is formed with a metallic spring portion 102 that becomes a main body of the contact 101. In order to obtain good conductivity, a continuity portion (not shown), such as an Au film or a Cu film, may be formed on the surface of the spring portion 102.

Then, in the third step, as shown in FIG. 9C, the resist film 123, the seed film 104, and the resist cone 122 are removed in order after the formation of the spring portion 102.

However, in the conventional contact 101, as shown in FIG. 9C, the spring portion 102 is made of metal. Thus, sliding deformation of the spring portion 102 at a temperature rise in a conduction test of a semiconductor device (not shown) occurs easily, and if the conduction test is repeatedly performed, there is a problem in that the contact 101 deforms permanently and yields.

Further, since the spring portion 102 is formed using Ni—P that is a magnetic material, there is a problem in that a magnetic field may be formed around the spring portion 102. Therefore, there is a possibility that an adverse effect of the magnetic field is exerted on a semiconductor device in contact with the contact 101 by the conduction test.

### SUMMARY

Thus, the invention has been made in view of these points, and the object of the invention is to provide a contact and its manufacturing method capable of preventing the contact from yielding even if a conduction test of a semiconductor device is repeatedly performed, and capable of suppressing that an adverse effect of a magnetic field is exerted on the semiconductor device.

Further, another object the invention is to provide a contact and its manufacturing method capable of utilizing a conventionally used wiring substrate without the change thereof even if a material used for a spring portion is changed.

In order to attain the aforementioned objects, as a first aspect of the invention, a contact of the invention includes a spring portion formed using ceramic on the surface of a wiring substrate of a probe card, and a conductive portion formed using a conductive material so as to cover at least the surface of the spring portion that faces a bump, and connected to a wiring line formed on the wiring substrate. In addition, the conductive portion includes conductive portions in the broad sense of the term, including a conductive portion to be described below, which is obtained by continuously forming a surface-side conductive portion formed on the surface of the spring portion and a back-side conductive portion formed on the back of the spring portion, as well as the conductive portion formed on the surface of the spring portion.

According to the contact of the first aspect, since the spring portion of the contact is made of ceramic, the permanent deformation of the contact can be made hard to occur as compared with a conventional contact having a metallic spring portion, and the spring portion can be formed without using a magnetic material, such as Ni—P.

A contact of a second aspect of the invention is the contact of the first aspect in which the spring portion is formed in a solid spiral shape that protrudes toward the bump.

According to the contact of the second aspect, since the length of the spring portion can be increased, the permanent deformation of the contact can be made hard to occur, as compared with contacts having spring portions with other shapes.

A contact of a third aspect of the invention is the contact of the first or second aspect in which the spring portion is formed by an aerosol deposition method.

According to the contact of the third aspect, since the spring portion made of ceramic can be formed as a film at room temperature, it is possible to prevent a thermal adverse effect from being exerted on the wiring substrate or wiring lines of the probe card during the formation of the spring portion.

A contact of a fourth aspect of the invention is the contact of any one of the first to third aspects in which the ceramic is zirconia-based ceramic.

According to the contact of the fourth aspect, it is possible to form the spring portion that is excellent in mechanical properties, such as strength, toughness, wear resistance, and loop deformation property.

A contact of a fifth aspect of the invention is the contact of the fourth aspect in which zirconia-based ceramic is yttria stabilized zirconia or yttria partially-stabilized zirconia.

According to the contact of the fifth aspect, since yttria stabilized zirconia or yttria partially-stabilized zirconia is obtained by solid-dissolving yttria in zirconia, it is possible to suppress phase transition of the zirconia caused by a temperature rise. Therefore, as compared with the spring portion formed using oxide-free zirconia-based ceramic, the spring portion having an excellent mechanical property can be formed.

A contact of a sixth aspect of the invention is the contact of any one of the first to fifth aspects in which the conductive portion is formed by plating using Ni—P, or Cu/Ni—P laminated metal in which Ni—P is laminated on Cu, at the surface of the spring portion.

According to the contact of the sixth aspect, since Ni—P is excellent in wear resistance, it is possible to prevent the conductive portion from being shaved off as the conductive portion repeatedly contacts the bump. Further, since the film thickness of the conductive portion can be made small as compared with the film thickness of the spring portion, it is possible to minimize the adverse effect of the magnetic field of a semiconductor device caused by the contact. Moreover, in a case where a Cu layer is provided on a lower layer of Ni—P, the wear resistance and conductivity of the conductive portion can be improved.

A contact of a seventh aspect of the invention is the contact of the sixth aspect in which the conductive portion is formed on the surface of the spring portion that has on its surface a seed film with a Cr/Cu laminated structure that uses Cr for a lower layer and uses Cu for an upper layer.

According to the contact of the seventh aspect, since the Cr lower layer has good adhesiveness to the spring portion made of ceramic, it is possible to prevent the conductive portion from being peeled off from the surface of the spring portion. Further, since the conductivity of the Cu upper layer is excellent, the conductive portion can be easily formed by plating.

A contact of an eighth aspect of the invention is the contact of the sixth or seventh aspect in which the conductive portion is electrically connected from the surface side of the spring portion, and is formed at the back of the spring portion using Cu.

According to the contact of the eighth aspect, since Cu has more excellent conductivity than Ni—P used for the conductive portion formed at the surface of the spring portion, it is possible to improve the conductivity of the conductive portion at its back that a bump does not contact.

A contact of a ninth aspect of the invention is the contact of any one of the first to eighth aspects in which the conductive portion has a protective film, which is formed using Au, on the surface of the conductive portion.

According to the contact of the ninth aspect, the conductivity and oxidation resistance of the conductive portion can be improved.

Further, in order to achieve the aforementioned objects, as a first aspect of the invention, a manufacturing method of a contact of the invention includes: a step 1a of forming a first resist in a conical shape on the surface of a wiring substrate of a probe card; a step 1b of forming a second resist in the shape of a film on the surface of the conical first resist, and patterning a solid spiral groove in the second resist; a step 1c of jetting ceramic onto the conical first resist that has the second resist on its surface to form a film, and thereby forming a spring portion made of ceramic inside the groove formed in the second resist; a step 1d of removing the second resist and the first resist after the formation of the spring portion; a step 1e of forming a seed film on the surface of the spring portion and the surface of the wiring substrate by sputtering after the removal of the second resist and the first resist; a step if of forming a third resist in the shape of a film on the surface of the seed film and the surface of the wiring substrate, and performing on the third resist the patterning of exposing the seed film formed on the surface of the spring portion and on the surface of the wiring substrate from the spring portion to a wiring line formed on the wiring substrate; a step 1g of forming a conductive portion by plating on the surface of the seed film exposed from the third resist; and a step 1h of removing the third resist after the formation of the conductive portion, and removing the seed film exposed by the removal of the third resist.

According to the manufacturing method of a contact of the first aspect, since the spring portion is formed using ceramic, the contact that permanent deformation is hard to occur as compared with the conventional contact in which a spring portion is formed using metal can be manufactured, and the spring portion can be formed without using a magnetic material, such as Ni—P.

A manufacturing method of a contact according to a second aspect of the invention includes: a step 2a of forming a first resist in a conical shape on the surface of a wiring substrate of a probe card; a step 2b of forming a back-side seed film by sputtering on the surface of the first resist and the surface of the wiring substrate; a step 2c of forming a second resist in the shape of a film on the surface of the back-side seed film, and patterning a solid spiral groove in the second resist; a step 2d of forming a back-side conductive portion in the shape of a film on the back-side seed film exposed from the groove of the second resist; a step 2e of jetting ceramic onto the surface of the back-side conductive portion and the surface of the second resist to form a film, and thereby forming a spring portion made of ceramic on the surface of the back-side conductive portion exposed from the groove of the second resist; a step 2f of removing the second resist after the formation of the spring portion; a step 2g of removing the back-side seed film exposed by the removal of the second resist; a step 2h of removing the first resist after the removal of the back-side seed film; a step 2i of forming a surface-side seed film by sputtering on the surface of the spring portion and the surface of the wiring substrate so as to be electrically connected to the back-side seed film formed at the back of the back-side conductive portion after the removal of the first resist; a step 2j of forming a third resist in the shape of a film on the surface-side seed film formed on the surface of the wiring substrate; a step 2k of forming a surface-side conductive portion on the surface-side seed film exposed after the formation of the third resist; and a step 2l of removing the third resist after the formation of the surface-side conductive portion, and removing the surface-side seed film exposed by the removal of the third resist.

According to the manufacturing method of a contact of the second aspect, since the spring portion is formed using ceramic, the contact that permanent deformation is hard to occur as compared with the conventional contact in which a spring portion is formed using metal can be manufactured, and the spring portion can be formed without using a magnetic material, such as Ni—P. Further, since electrical connection can be made even at the back of the spring portion by the back-side conductive portion electrically connected to the surface-side conductive portion. Thus, even if the spring portion is formed on the surface of a wiring line of the wiring substrate, the contact can be electrically connected to the wiring line.

A manufacturing method of a contact according to a third aspect of the invention includes: a step 3a of forming a first resist in a conical shape on the surface of a wiring substrate of a probe card; a step 3b of forming a back-side seed film by sputtering on the surface of the first resist and the surface of the wiring substrate; a step 3c of forming a second resist in the shape of a film on the surface of the back-side seed film, and patterning a solid spiral groove in the second resist; a step 3d of forming a back-side conductive portion in the shape of a film on the back-side seed film exposed from the groove of the second resist; a step 3e of removing the second resist after the formation of the back-side conductive portion, removing the back-side seed film exposed by the removal of the second resist, and removing the first resist after the removal of the back-side seed film; a step 3f of jetting ceramic onto the surface of the back-side conductive portion exposed by the removal of the second resist to form a film, and thereby forming a spring portion made of ceramic on the surface of the back-side conductive portion; a step 3g of forming a surface-side seed film by sputtering on the surface of the spring portion and the surface of the wiring substrate so as to be electrically connected to the back-side seed film formed at the back of the back-side conductive portion after the removal of the spring portion; a step 3h of forming a third resist in the shape of a film on the surface-side seed film formed on the surface of the wiring substrate; a step 3i of forming a surface-side conductive portion on the surface-side seed film formed on the surface of the spring portion, after the formation of the third resist; and a step 3j of removing the third resist after the formation of the surface-side conductive portion, and removing the surface-side seed film exposed by the removal of the third resist.

According to the manufacturing method of a contact of the third aspect, since the spring portion is formed using ceramic, the contact that permanent deformation is hard to occur as compared with the conventional contact in which a spring portion is formed using metal can be manufactured, and the spring portion can be formed without using a magnetic material, such as Ni—P. Further, since electrical connection can be made even at the back of the spring portion by the back-side conductive portion electrically connected to the surface-side conductive portion. Thus, even if the spring portion is formed on the surface of a wiring line of the wiring substrate, the contact can be electrically connected to the wiring line. Moreover, in the step 3f, the spring portion made of ceramic is formed after the first resist and the second resist that do not have thermal resistance is removed, the spring portion can be sintered at a high temperature.

A manufacturing method of a contact according to a fourth aspect of the invention is the manufacturing method of a contact of any one of the first to third aspects in which the spring portion is formed by the aerosol deposition method.

According to the manufacturing method of a contact of the fourth aspect, since the spring portion made of ceramic can be formed as a film at room temperature, it is possible to prevent a thermal adverse effect from being exerted on the wiring substrate or wiring lines of the probe card during the formation of the spring portion.

A manufacturing method of a contact according to a fifth aspect of the invention is the manufacturing method of a contact of any one of the first to fourth aspects in which he ceramic is zirconia-based ceramic.

According to the manufacturing method of a contact of the fifth aspect, it is possible to form the spring portion that is excellent in mechanical properties, such as strength, toughness, wear resistance, and loop deformation property.

A manufacturing method of a contact according to a sixth aspect of the invention is the manufacturing method of a contact of the fifth aspect in which the zirconia-based ceramic is yttria stabilized zirconia or yttria partially-stabilized zirconia,

According to the manufacturing method of a contact of the sixth aspect, since yttria stabilized zirconia or yttria partially-stabilized zirconia is obtained by solid-dissolving yttria in zirconia, it is possible to suppress phase transition of the zirconia caused by a temperature rise. Therefore, as compared with the spring portion formed using oxide-free zirconia-based ceramic, the spring portion having an excellent mechanical property can be formed.

A manufacturing method of a contact according to a seventh aspect of the invention is the manufacturing method of a contact of any one of the first to sixth aspects in which the conductive portion or surface-side conductive portion is formed by plating using Ni—P, or Cu/Ni—P laminated metal in which Ni—P is laminated on Cu

According to the manufacturing method of a contact of the sixth aspect, since Ni—P is excellent in wear resistance, it is possible to prevent the conductive portion or surface-side conductive portion from being shaved off as the conductive portion or surface-side conductive portion repeatedly contacts the bump. Further, since the film thickness of the conductive portion or surface-side conductive portion can be made small as compared with the film thickness of the spring portion, it is possible to minimize the adverse effect of the magnetic field of a semiconductor device caused by the contact. Moreover, in a case where a Cu layer is provided on a lower layer of Ni—P, the wear resistance and conductivity of the conductive portion or surface-side conductive portion can be improved.

A manufacturing method of a contact according to an eighth aspect of the invention is the manufacturing method of a contact of any one of the first to seventh aspects in which the back-side conductive portion has a protective film, which is formed by plating using Cu.

According to the manufacturing method of a contact of the eighth aspect, since Cu has excellent conductivity, it is possible to improve the conductivity of the whole conductive portion composed of the surface-side conductive portion and the back-side conductive portion.

A manufacturing method of a contact according to a ninth aspect of the invention is the manufacturing method of a contact of any one of the first to eighth aspects in which the seed film or surface-side seed film is formed as a Cr/Cu laminated structure that uses Cr for a lower layer and uses Cu for an upper layer.

According to the manufacturing method of a contact of the ninth aspect, since the Cr lower layer has good adhesiveness to the spring portion made of ceramic, it is possible to prevent the conductive portion or surface-side conductive portion from being peeled off from the surface of the spring portion. Further, since the conductivity of the Cu upper layer is excellent, the conductive portion or surface-side conductive portion can be easily formed by plating.

A manufacturing method of a contact according to a tenth aspect of the invention is the manufacturing method of a contact of any one of the first to ninth aspects in which the back-side seed film is formed as a Ti/Cu laminated structure that uses Ti for a lower layer and uses Cu for an upper layer.

According to the manufacturing method of a contact of the tenth aspect, since the Ti lower layer has good adhesiveness to a resist, the back-side seed film having a uniform film thickness can be formed on the first resist. Further, since the conductivity of the Cu upper layer is excellent, the back-side conductive portion can be easily formed by plating.

A manufacturing method of a contact according to the eleventh aspect of the invention is the manufacturing method of a contact of any one of the first to tenth aspects in which the conductive portion or surface-side conductive portion has a protective film that is formed using Au on the surface thereof.

According to the manufacturing method of a contact of the eleventh aspect, the conductivity and oxidation resistance of the conductive portion or surface-side conductive portion can be improved.

According to the contact and its manufacturing method of the invention, mechanical property is improved by making the spring portion of ceramic with no magnetism. Thus, the contact can be prevented from yielding even if a conduction test of a semiconductor device is repeatedly performed, and it is possible to suppress that an adverse effect of a magnetic field is exerted on the semiconductor device.

Further, according to the contact and its manufacturing of the invention, the spring portion made of ceramic can be formed at room temperature. Thus, a conventionally used wiring substrate can be utilized without the change thereof.

### BRIEF DESCRIPTION OF THE DRAWINGS

FIG. 1 is a perspective view showing a contact of a first embodiment;

FIG. 2 is a sectional view taken along a line 2-2 of FIG. 1;

FIG. 3 is a longitudinal sectional view showing a manufacturing method of a contact according to the first embodiment in order of A to I;

FIG. 4 is a conceptual diagram showing a state where a spring portion is formed on the surface of a first resist by an aerosol deposition method;

FIG. 5 is a longitudinal sectional view showing a contact of a second embodiment;

FIG. 6 is a longitudinal sectional view showing a manufacturing method of a contact according to the second embodiment in order of A to L;

FIG. 7 is a longitudinal sectional view showing a contact of a third embodiment;

FIG. 8 is a longitudinal sectional view showing a manufacturing method of a contact according to the third embodiment in order of A to L; and

FIG. 9 is a longitudinal sectional view showing a conventional manufacturing method of a contact in order of A to C.

### DESCRIPTION OF THE EMBODIMENTS

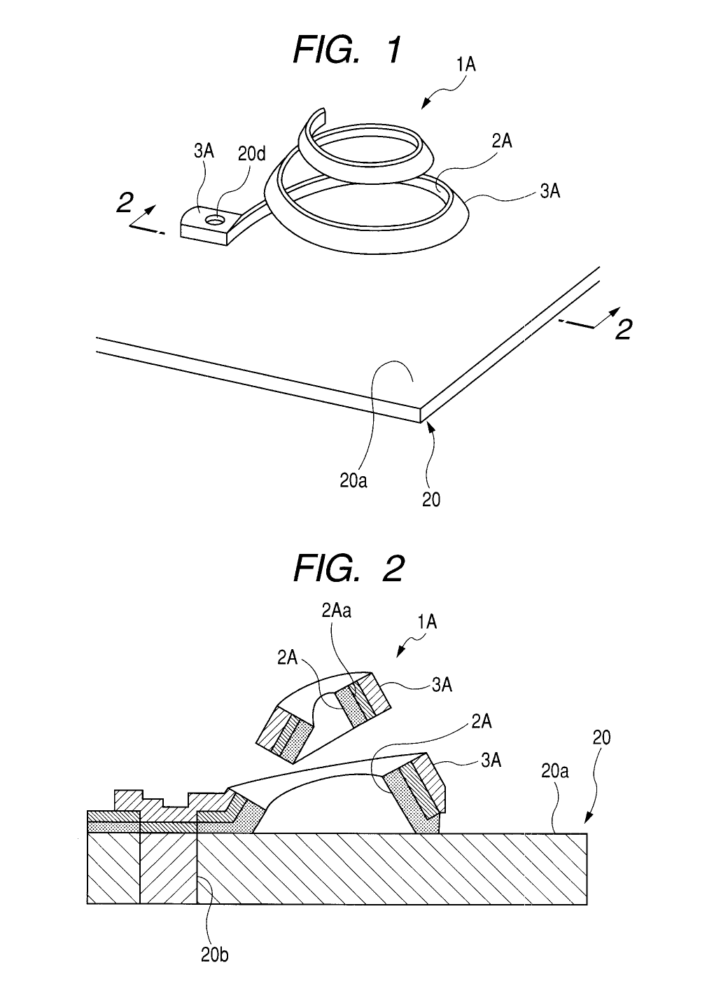

Hereinafter, a contact of the invention will be described by first to third embodiments thereof with reference to FIGS. 1 to 9.

First, a contact 1A of a first embodiment will be described with reference to FIGS. 1 and 2. FIG. 1 shows the perspective view of the contact 1A of the first embodiment. Further, FIG. 2 shows a sectional view taken along a line 2-2 of FIG. 1.

As shown in FIGS. 1 and 2, the contact 1A of the first embodiment includes a spring portion 2A and a conductive portion 3A.

The spring portion 2A is formed on the surface of a wiring substrate 20a of a probe card 20, using ceramic. If the shape of the spring portion 2A is the shape of a spring that exhibits an elastic force in a vertical direction, such as a coil spring, a leaf spring, or a disc spring, various shapes can be selected. As the shape of the spring portion 2A of the first embodiment, a convex solid spiral shape that protrudes toward a bump (upper portion of FIG. 2) is selected. In that case, the spring portion 2A is dimensioned such that the diameter thereof is about 200 μm, and the height thereof is about 100 μm.

Further, the spring portion 2A is formed by an aerosol deposition method capable of forming the spring portion at room temperature. The aerosol deposition method is a film-forming method that mixes ceramic particulates with inert gas within a chamber having a nozzle to aerosolize them, and sprays the aerosolized ceramic particulates to a substrate to form a ceramic coat on the surface of the substrate. As the ceramic used for the spring portion 2A, ceramic that can be formed as a film using the aerosol deposition method, such as an alumina-based ceramic, yttria-based ceramic, and zirconia-based ceramic, can be selected. In the first embodiment, the zirconia-based ceramic that is excellent in mechanical properties, such as strength, toughness, wear resistance, and loop deformation property, is selected. Particularly, it is preferable to select as zirconia-based ceramic yttria stabilized zirconia or yttria partially-stabilized zirconia that is stable against phase transition at temperature rise or drop.

The conductive portion 3A is formed so as to cover a surface 2Aa of the spring portion 2A that faces a bump (not shown) using a conductive material. This conductive material may be formed using Ni—P that is excellent in mechanical property, or Cu that is excellent in conductivity, and may be laminated metal of Ni—P and Cu. In a case where the laminated metal is used, a lower layer (not shown) is formed in the surface 2Aa of the spring portion 2A by using Cu, and an upper layer (not shown) is formed on the surface of the lower layer by using Ni—P.

Further, the conductive portion 3A is connected to a wiring line formed in the wiring substrate 20a. The wiring line may be a wiring pattern (not shown) formed on the surface of the wiring substrate 20a, and may be a via hole 20b exposed from the wiring substrate 20a as shown in FIG. 2.

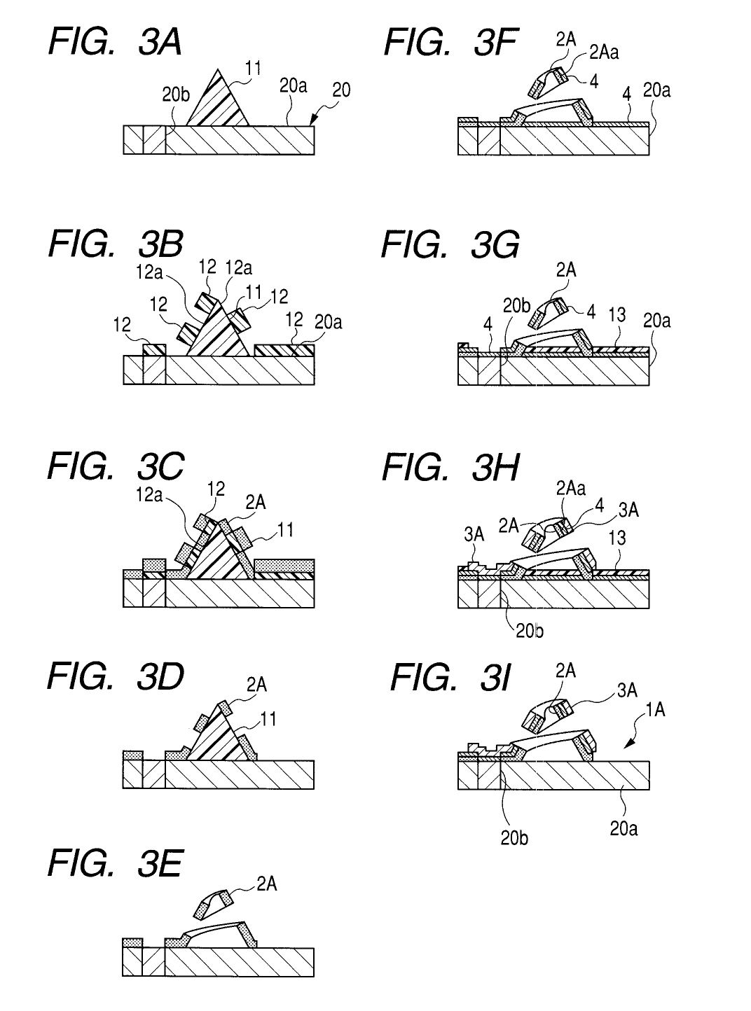

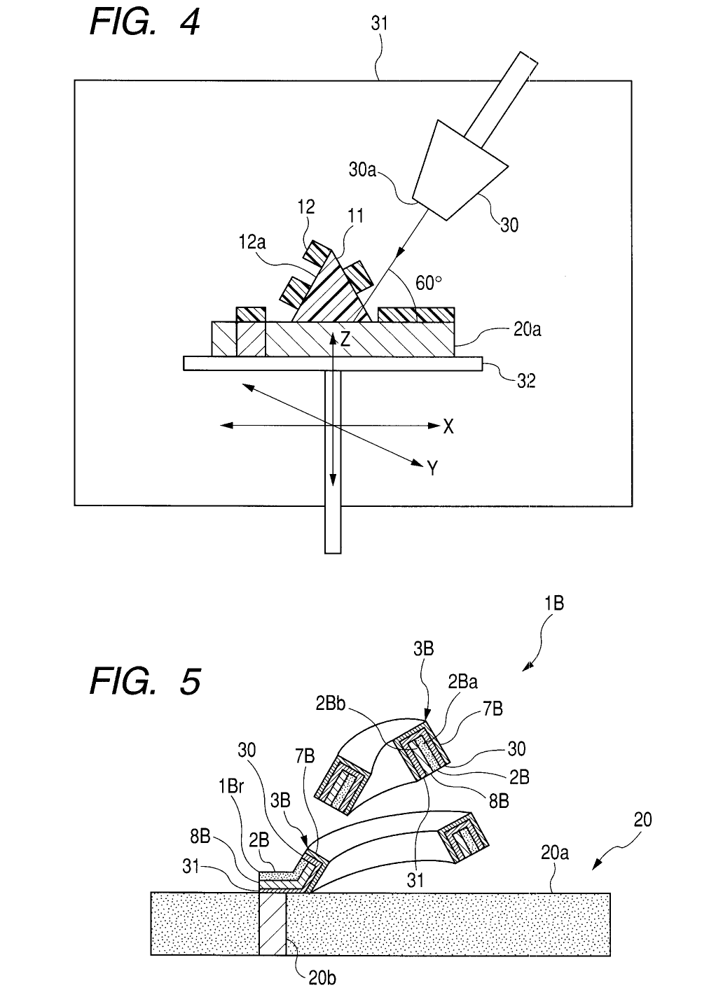

Next, a manufacturing method of the contact 1A according to the first embodiment will be described with reference to FIGS. 3 and 4. Here, FIG. 3 is a longitudinal sectional view showing the manufacturing method of the contact 1A according to the first embodiment in order of A to I. Further, FIG. 4 is a conceptual diagram showing a state where the spring portion 2A is formed on the surface of a first resist 11 by the aerosol deposition method.

The contact 1A of the first embodiment is manufactured through Steps 1a to 1h.

In Step 1a, as shown in FIG. 3A, the first resist 11 is formed in a conical shape on the surface of the wiring substrate 20a of the probe card 20. For example, as a method of making the first resist 11, the first resist 11 is formed in a conical shape by forming a resist film (not shown) having a film thickness of 100 μm on the surface of the wiring substrate 20a, resist-coating the resist film, and then developing the resist film by performing multiple exposure (hereinafter, a series of steps including resist coating, exposure, and development are referred to as “patterning”). The first resist 11 is dimensioned such that the diameter thereof is about 200 μm, and the height thereof is about 100 μm. A novolak-based resist material is selected as the resist material used for the first resist 11.

In Step 1b, a resist material is coated on the surface of the conical first resist 11 and the surface of the wiring substrate 20a that are shown in FIG. 3 A to form a second resist 12 in the shape of a film (refer to FIG. 3B). The film thickness of this second resist 12 is about 30 μm. After the formation of the second resist 12, as shown in FIG. 3B, a solid spiral groove 12a is patterned in the second resist 12. As the resist material used for the second resist 12, a novolak-based resist material is selected similarly to the first resist 11.

In Step 1c, as shown in FIG. 3C, the spring portion 2A made of ceramic is formed inside the solid spiral groove 12a formed in the second resist 12 by jetting ceramic onto the conical first resist 11 having the second resist 12 on its surface, thereby forming a film. Although the method of jetting ceramic used for the spring portion 2A may include the aerosol deposition method, the sputtering method, etc., the aerosol deposition method that allows ceramic film formation at room temperature is adopted in the first embodiment.

Here, the method of forming method the spring portion 2A using the aerosol deposition method will be described in detail with reference to FIG. 4. In the first embodiment, in an aerosol chamber (not shown) connected to a nozzle 30 as shown in FIG. 4, as ceramic particulates having a particle size of 0.3 to 1 μm is mixed with helium gas called carrier gas, ceramic particulates are aerosolized. The tip gap (not shown) in an opening 30a of the nozzle 30 is set to 0.5 μm, and the slit width (not shown) is set to about 5 mm. Further, the nozzle 30 is disposed inside a deposition chamber 31 reduced in pressure to about several Pa so as to incline at about 60 degrees with respect to the wiring substrate 20a. Then, by releasing the opening 30a of the nozzle 30, the ceramic particulates aerosolized inside the aerosol chamber are jetted onto the surface of the wiring substrate 20a and the surface of the first resist 11 through the nozzle 30.

As shown in FIG. 4, the wiring substrate 20a is placed on an XYZ stage 32. The XYZ stage 32 reciprocatively slides at a speed of 10 mm/sec in an X-direction, and is steppingly fed at 5 mm in a Y-direction. Since the slit width of the nozzle 30 is 5 mm, and the distance between the wiring substrate 20a or first resist 11, and the nozzle 30 is set to about 50 mm, the ceramic particulate aerosolized during film formation of ceramic are spread to a width of about 10 mm and is formed as a film. Further, since the Y-step amount is 5 mm, the ceramic particulates overlap each other at the time of Y-stepping, and are formed as a film. In a case where the inclination of the conical first resist 11 is 45 degrees or more, there is a possibility that the film-forming rate of the spring portion 2A formed on the surface of the first resist 11 may become late, or a film may not be formed normally. Therefore, the rotation of ±30 degrees/sec based on an X-axis is also added during the reciprocal operation of the XYZ stage 32 in the X-direction.

After the step feed in the Y-direction is completed once, and ceramic is formed as a film throughout the surface of the wiring substrate 20a, the wiring substrate 20a is rotated 90 degrees, and a second film-forming operation is generally performed around a Z-axis. Even if the Y-step feed is completed only once throughout the surface of the wiring substrate 20a, the film thickness of the spring portion 2A is about several micrometers, and a desired film thickness cannot be obtained. Therefore, in order to obtain the spring portion 2A having a thickness of 10 to 20 μm, a series of the operations is repeated several times.

By repeating the operations of the X sliding and Y stepping several times, the aerosolized ceramic particulates are formed as a film on the surface of the wiring substrate 20a, and the surface of the first resist 11 at room temperature, and the spring portion 2A having a desired thickness (for example, a film thickness of about 30 μm) can be formed (refer to FIG. 3C).

As the ceramic used for the spring portion 2A, fine ceramics, such as alumina-based ceramic, yttria-based ceramic, and zirconia-based ceramic, are preferable, and among them, zirconia-based ceramic is more preferable. Moreover, yttria stabilized zirconia or yttria partially-stabilized zirconia is preferable as the zirconia-based ceramic. In the first embodiment, as the yttria stabilized zirconia (zirconia containing yttria 4.9 wt % and alumina 0.38 wt %), for example, zirconia powder (TZ-3Y-E) made by Tosoh Corp. is selected. Further, the particle size of the yttria-stabilized-zirconia particulates is 0.4 μm.

In Step 1d, as shown in FIG. 3D, the second resist 12 is removed after the formation of the spring portion 2A. By the removal of the second resist 12, the ceramic formed as a film on the surface of the second resist 12 during the formation of the spring portion 2A is lifted off. After the removal of the second resist 12, as shown in FIG. 3E, the first resist 11 is removed. As a remover for the first resist 11 and the second resist 12, N-methyl-2-pyrrolidone (molecular formula: C₅H₉NO, and brand name: NMP) is used.

In Step 1e, as shown in FIG. 3F, a the seed film 4 is formed on the surface 2Aa of the spring portion 2A, and the surface of the wiring substrate 20a by sputtering after the removal of the second resist 12 and the first resist 11. It is desirable that the seed film 4 is formed using a conductive material because it will become a foundation film for forming the conductive portion 3A by plating. However, in the first embodiment, the seed film 4 is formed by forming a Cr film or Ti film (not shown) having good adhesiveness to the ceramic on the surface of surface 2Aa of the spring portion 2A and the wiring substrate 20a with a film thickness of about 15 nm by sputtering, and then forming a Cu film (not shown) having good conductivity on the surface of a Cr film or Ti film with a film thickness of about 100 nm.

In Step if, a resist material is coated on the surface of the seed film 4 to form a third resist 13 in the shape of a film (refer to the FIG. 3G). The film thickness of the third resist 13 is about 5 μm. Then, as shown in FIG. 3G, the third resist 13 is subjected to the patterning of exposing the seed film 4 formed on the surface 2Aa of the spring portion 2A and on the surface of the wiring substrate 20a from the spring portion 2A to the via hole 20b formed in the wiring substrate 20a. As the resist material used for the third resist 13, a novolak-based resist material is selected similarly to the first resist 11 and the second resist 12.

In Step 1g, as shown in FIG. 3H, the conductive portion 3A is formed by plating on the surface of the seed film 4 exposed from the third resist 13. It is desirable that the conductive portion 3A is formed using a conductive material. For example, the conductive portion 3A may be formed using Cu that is excellent in conductivity, and may be formed using Ni—P that is excellent in wear resistance. In the first embodiment, the conductive portion 3A is formed by a lower layer (not shown) that is formed on the surface 2Aa of the spring portion 2A using Cu and has a film thickness of 5 μm, and an upper layer (not shown) that is formed on the surface of the lower layer using Ni—P that is excellent in wear resistance, and has a film thickness of 2 μm. In a case where the contact 1A is used under an atmosphere in which the surface of the conductive portion 3A is easily oxidized, it is preferable to form a protective film using Au for the surface of the conductive portion 3A.

In Step 1h, as shown in FIG. 3I, the third resist 13 is removed after the formation of the conductive portion 3A, and the seed film 4 exposed by the removal of the third resist 13 is removed. As a remover for the third resist 13, N-methyl-2-pyrrolidone (molecular formula: C₅H₉NO and brand name: NMP) is used similarly to the remover for the first resist 11 and the second resist 12. Further, ion milling is used for removal of the seed film 4. As the removal of the seed film 4 is finished, the manufacturing process of the contact 1A is finished.

Next, the effects of the contact 1A of the first embodiment and its manufacturing method will be described with reference to FIGS. 1 to 4.

As shown in FIGS. 1 and 2, the contact 1A of the first embodiment includes he spring portion 2A made of ceramic, and the conductive portion 3A having conductivity. The contact 1A is disposed on the probe card 20, and a bump of a semiconductor device to be tested is disposed in a position that faces a convex direction of the contact 1A. In the case of a conduction test of a semiconductor device, the contact 1A is exposed under an atmosphere of a high temperature and a high voltage in a state where it has been pushed down on the bump.

Here, in the contact 1A of the first embodiment, the spring portion 2A is made of ceramic. Therefore, the permanent deformation of the contact 1A can be made hard to occur as compared with the conventional contact 101 (refer to FIG. 9) that has the metallic spring portion 102. Further, since the spring portion 2A is formed without using a magnetic material, such as Ni—P, an adverse effect is not exerted on a semiconductor device (not shown) to be tested.

Generally, although the film formation of ceramic is performed by sintering, the wiring substrate 20a will be deformed or broken by sintering of the ceramic if the wiring substrate 20a has no thermal resistance. Therefore, the spring portion 2A is formed by the aerosol deposition method. According to the aerosol deposition method, a film can be formed similarly to when ceramic particulates are sintered as they are jetted onto and made to collide against a formed substrate. That is, since the spring portion 2A made of ceramic can be formed as a film at room temperature, it is possible to prevent a thermal adverse effect from being exerted on the wiring substrate 20a or wiring lines of the probe card 20 during the formation of the spring portion 2A.

Further, the zirconia-based ceramic is selected as the ceramic used for the spring portion 2A. The zirconia-based ceramic is excellent in mechanical properties, such as strength, toughness, wear resistance, and loop deformation property even in comparison with not only spring metal, such as Ni—P, but other fine ceramics, such as alumina. Therefore, even if the contact 1A is repeatedly deformed at a high temperature it is possible to form the spring portion 2A that is hard to deform permanently and is excellent in mechanical property. In particular, if stabilized zirconia, such as yttria stabilized zirconia or yttria partially-stabilized zirconia, which is obtained by solid-dissolving yttria dissolved into zirconia, it is possible to suppress phase transition of the zirconia caused by a temperature rise. Therefore, as compared with the spring portion 2A formed using oxide-free zirconia-based ceramic, the spring portion 2A formed using the stabilized zirconia can exhibit an excellent mechanical property.

In addition, the difference between the yttria stabilized zirconia and the yttria partially-stabilized zirconia is a difference in the content of yttria, and accordingly, oxygen ion conductivity or a mechanical property differ. In a case where it is intended to improve the oxygen ion conductivity of the spring portion 2A, it is desirable to select the yttria stabilized zirconia having much yttria content, and in a case where it is intended to improve the mechanical property of the spring portion 2A, it is desirable to select to select the yttria partially-stabilized zirconia having little yttria content.

Moreover, the spring portion 2A is formed in a solid spiral shape that protrudes toward the bump. Accordingly, since the length of the spring portion 2A can be increased, the permanent deformation of the contact 1A can be made hard to occur, as compared with the spring portion 2A having other shapes.

Since the spring portion 2A is made of ceramic, it is not possible to electrically connect the bump that has contacted the contact 1A via the spring portion 2A to the via hole 20b of the wiring substrate 20a. Therefore, the conductive portion 3A is formed on the surface 2Aa of the spring portion 2A that faces the bump. Since the conductive portion 3A is connected to a wiring line of the wiring substrate 20a, the contact 1A can electrically connect the bump and the wiring line of the wiring substrate 20a via the conductive portion 3A.

There are several alternatives as the conductive material used for the conductive portion 3A. For example, in a case where the conductive portion 3A is formed using Ni—P, the Ni—P is excellent in wear resistance as compared with other conductive materials. Therefore, it is possible to prevent the conductive portion 3A from being worn and shaved off as the conductive portion 3A repeatedly contacts the bump. Further, since the film thickness of the conductive portion 3A can be made small as compared with the film thickness of the spring portion 2A, it is possible to minimize that an adverse effect is exerted on the magnetic field of a semiconductor device by the contact 1A. Further, for example, in a case where the conductive portion 3A is formed using Cu, since Cu has excellent conductivity, it is possible to improve the conductivity of the conductive portion 3A.

In order to make use of the excellent features of both Ni—P and Cu, the conductive portion 3A of the first embodiment a lower layer (not shown) that is formed on the surface 2Aa of the spring portion 2A using Cu, and an upper layer that is formed on the surface of the lower layer using Ni—P. Since Cu used for the lower layer has excellent conductivity, it is possible to improve the conductivity of the conductive portion 3A. Further, since Ni—P used for the upper layer is excellent in wear resistance, it is possible to prevent the conductive portion 3A from being shaved off as the conductive portion 3A repeatedly contacts the bump. Moreover, since the film thickness of the upper layer of the conductive portion 3A can be made small as compared with the film thickness of the conventional metallic spring portion, it is possible to minimize an adverse effect on the magnetic field of a semiconductor device caused by the contact 1A.

Since the contact 1A of the first embodiment is used for the probe card 20, the contact 1A is often used under an atmosphere of a high temperature and a high voltage. Therefore, there is a risk that the conductive portion 3A that is the surface layer of the contact 1A may always be oxidized. Thus, it is preferable that a protective film be formed on the surface of the conductive portion 3A using Au. If an Au protective film is formed on the surface of the conductive portion 3A, it is possible to improve the oxidation resistance of the conductive portion 3A, and it is also possible to improve the conductivity of the conductive portion 3A.

In order to obtain the contact 1A having such features, the manufacturing method of the contact 1A according to the first embodiment includes Steps 1a to 1h as shown in FIG. 3.

Here, in Step 1c, as shown in FIG. 3C, the spring portion 2A made of ceramic is formed inside the solid spiral groove 12a formed in the second resist 12 by jetting ceramic onto the conical first resist 11 having the second resist 12 on its surface, thereby forming a film. Therefore, the contact 1A that permanent deformation is hard to occur as compared with the conventional contact 101 can be manufactured, and the spring portion 2A can be formed without using a magnetic material, such as Ni—P.

Further, since the sintering step of ceramic is generally included when the spring portion 2A is formed in Step 1c, the first resist 11 and the second resist 12 that have been formed in Step 1a and Step 1b have a possibility of being melted unless they are a material having high thermal resistance, such as metal or ceramic. Thus, in the first embodiment, the spring portion 2A is formed by the aerosol deposition method. Therefore, since the spring portion 2A made from ceramic can be formed at room temperature, even in a case where the first resist 11 and the second resist 12 serving as molds for the spring portion 2A during the formation of the spring portion 2A do not have high thermal resistance, they can be prevented from being melted. Of course, a thermal adverse effect can be prevented from being exerted on the wiring substrate 20a or via hole 20b of the probe card 20.

In addition, as the ceramic to be used, it is preferable to select zirconia-based ceramic, particularly, stabilized zirconia, as mentioned above.

Further, in Step 1g, as shown in FIG. 3H, the conductive portion 3A is formed by plating on the surface of the seed film 4 exposed from the third resist 13. Accordingly, the conductive portion 3A is formed on the surface 2Aa of the spring portion 2A via the seed film 4. Since a bump of a semiconductor device is disposed in the protruding direction of the contact 1A, the contact 1A can electrically connect the bump and the via hole 20b of the wiring substrate 20a by forming the conductive portion 3A on the surface 2Aa of the spring portion 2A, and bringing the bump into contact with the contact 1A. Further, by using Cu, Ni—P, or Cu/Ni—P laminated metal for a continuity portion, the conductive portion 3A that is excellent in conductivity, wear resistance or conductivity, and wear resistance can be formed. Moreover, since the amount of Ni—P to be used is small, the adverse effect of the magnetic field of a semiconductor device can be minimized.

Next, a contact 1B of a second embodiment will be described with reference to FIG. 5. Here, FIG. 5 is a longitudinal sectional view showing the contact 1B of the second embodiment. In addition, description about points that are common to the first embodiment will be omitted or made simply.

As shown in FIG. 5, the contact 1B of the second embodiment includes a spring portion 2B and a conductive portion 3B.

The spring portion 2B is formed on the surface of the wiring substrate 20a of the probe card 20, using ceramic. The spring portion 2B is the same as that of the first embodiment.

The conductive portion 3B has a surface-side conductive portion 7B that covers a surface 2Ba of the spring portion 2B that faces the bump using a conductive material, and a back-side conductive portion 8B that covers a back 2Bb. Further, the surface-side conductive portion 7B and the back-side conductive portion 8B are electrically connected as they are formed continuously. That is, the second embodiment is different from the first embodiment in that the conductive portion 3B is formed even on the back 2Bb of the spring portion 2B. The conductive material used for the surface-side conductive portion 7B and the back-side conductive portion 8B mainly includes metals, such as Cu, Cr, Au, and Ni—P. In the second embodiment, the surface-side conductive portion 7B is formed by plating on the surface of a Cr/Cu surface-side seed film 30 using Ni—P, and the back-side conductive portion 8B is formed on the surface of a Ti/Cu back-side seed film 31 using Cu. The contact 1B is electrically connected to the via hole 20b that exists under a root 1Br thereof via the conductive portion 3B (the surface-side conductive portion 7B and the back-side conductive portion 8B), the surface-side seed film 30, and the back-side seed film 31.

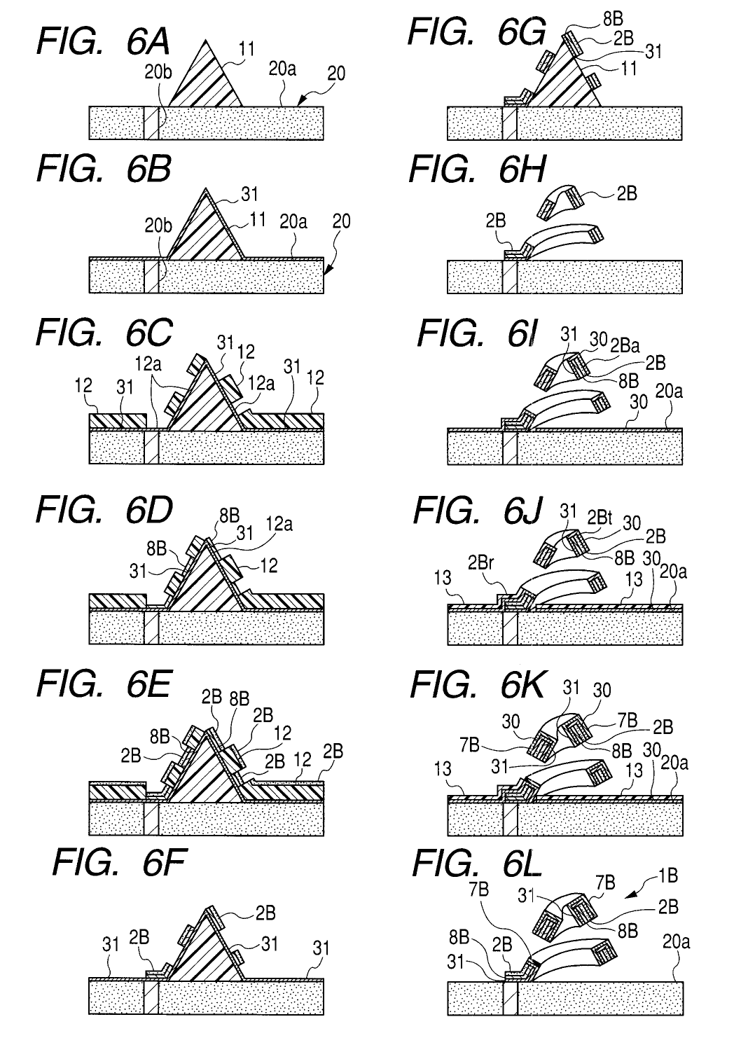

Next, a manufacturing method of the contact 1B of the second embodiment will be described with reference to FIG. 6. Here, FIG. 6 is a longitudinal sectional view showing the manufacturing method of the contact 1B of the second embodiment in order of A to L. In addition, description about points that are common to the first embodiment will be omitted or made simply.

The contact 1B of the second embodiment is manufactured through Steps 2a to 2l.

In Step 2a, as shown in FIG. 6A, the first resist 11 is formed in a conical shape on the surface of the wiring substrate 20a of the probe card 20. Further, the first resist 11 is formed so that the via hole 20b may be disposed at a peripheral edge of the first resist. In addition, the dimensions and resist material of the first resist 11 are the same as those of the first embodiment.

In Step 2b, as shown in FIG. 6B, the back-side seed film 31 is formed by sputtering on the surface of the first resist 11 and the surface of the wiring substrate 20a. As the conductive material used for the back-side seed film 31, a Ti/Cu laminated metal in which Ti that becomes a lower layer (not shown) and Cu that becomes an upper layer (not shown) are laminated. At this time, the back-side seed film 31 is obtained by forming the Cu upper layer having a film thickness of 3 μm on the surface of the Ti lower layer by sputtering after the Ti lower layer having a film thickness of 15 nm is formed by sputtering on the surface of the first resist 11 and the surface of the wiring substrate 20a.

In Step 2c, the second resist 12 is formed in the shape of a film on the surface of the back-side seed film 31 (refer to the FIG. 6C). Thereafter, as shown in FIG. 6C, the solid spiral groove 12a is patterned on the second resist 12. In addition, the resist material of the second resist 12 is the same as that of the first embodiment.

In Step 2d, as shown in FIG. 6D, the back-side conductive portion 8B is formed by plating in the shape of a film on the back-side seed film 31 exposed from the groove 12a of the second resist 12. As the back-side conductive portion 8B, Cu that is excellent in conductivity, Ni—P that is excellent in wear resistance, other good-conductive metals, or metals that are excellent in mechanical property can be selected. As the back-side conductive portion 8B of the second embodiment, Cu is selected in consideration of the fact that the back-side conductive portion 8B is covered with the back-side seed film 31 and spring portion 2B.

In Step 2e, as shown in FIG. 6E, ceramic is jetted onto the surface of the back-side conductive portion 8B and the surface of the second resist 12 to form a film. This forms the spring portion 2B having a thickness of 30 μm and made of ceramic on the surface of the back-side conductive portion 8B exposed from the groove of the second resist 12. In the second embodiment, the spring portion 2B is formed by the aerosol deposition method. As the ceramic used for the spring portion 2B, zirconia-based ceramic, particularly, yttria stabilized zirconia or yttria partially-stabilized zirconia is selected.

In Step 2f, as shown in FIG. 6F, the second resist 12 is removed by a resist remover after the formation of the spring portion 2B. The spring portion 2B formed on the surface of the second resist 12 is lifted off by this removal operation. In addition, the resist remover is the same as that of the first embodiment.

In Step 2g, as shown in FIG. 6G, the back-side seed film 31 exposed by the removal of the second resist 12 is removed by ion milling. The first resist 11 is exposed by the removal of the back-side seed film 31.

In Step 2h, as shown in FIG. 6H, the first resist 11 is removed by a resist remover after the removal of the back-side seed film 31. This exposes the back-side seed film 31 formed at the back of the back-side conductive portion 8B from the back side. In addition, the resist remover is the same as that of the first embodiment.

In Step 2i, as shown in FIG. 6I, the surface-side seed film 30 is formed by sputtering on the surface 2Ba of the spring portion 2B and the surface of the wiring substrate 20a after the removal of the first resist 11. The surface-side seed film 30 is formed continuously with the back-side seed film 31 so as to contact the back-side seed film 31 and be electrically connected thereto. In that case, the surface-side seed film 30 is formed by raising the gas pressure of a sputter so that the surface-side seed film 30 may go round to the back-side seed film 31 from the surface 2Ba of the spring portion 2B. In addition, although a portion that is covered with the spring portion 2B, and in which the surface-side seed film 30 is not formed is generated on the surface of the wiring substrate 20a, this doses not matter because the surface-side seed film 30 formed on the surface of the wiring substrate 20a is removed in the subsequent Step 2l.

In Step 2j, as shown in FIG. 6J, the third resist 13 is formed in the shape of a film on the surface-side seed film 30 formed on the surface of the wiring substrate 20a. The third resist 13 is not formed on the spring portion 2B as it is exposed while being focused on an apex 2Bt of the spring portion 2B during the formation of the third resist 13. Further, the third resist 13 is formed on the surface of the wiring substrate 20a as it is exposed without being focused on the surface of the wiring substrate 20a. As shown in FIG. 6J, the third resist 13 may be formed on a root 2Br of the spring portion 2B depending on focusing positions or exposure conditions. However, there is no problem even if the third resist 13 is formed on a portion of the spring portion 2B unless the third resist 13 is formed on the whole spring portion 2B.

In Step 2k, as shown in FIG. 6K, the surface-side conductive portion 7B is formed by plating on the surface-side seed film 30 exposed after the formation of the third resist 13. Since the surface-side seed film 31 is formed continuously with the back-side seed film 31, the surface-side conductive portion 7B is formed even on the back of the back-side seed film 31. However, since the back-side conductive portion 8B is formed at the back of the spring portion 2B, and accordingly, the conductivity of the spring portion 2B at the back thereof is secured, there is no problem even if plating formation of the surface-side conductive portion 7B is finished before the surface-side conductive portion 7B is formed on the back-side seed film 31.

In Step 2l, as shown in FIG. 2L, the third resist 13 is removed by a resist remover after the formation of the surface-side conductive portion 7B. Further, as shown in FIG. 2L, the surface-side seed film 30 exposed after the removal of the third resist 13 is removed by ion milling. The resist remover and ion milling are the same as those of the first embodiment.

The contact 1B of the second embodiment is manufactured through the above steps. In addition, similarly to the first embodiment, an Au protective film is formed on the surface of the conductive portion 3B.

Next, the effects of the contact 1B of the second embodiment and its manufacturing method will be described with reference to FIGS. 5 and 6. In addition, description about points that are common to the first embodiment will be omitted or made simply.

As shown in FIG. 5, the contact 1B of the second embodiment includes the spring portion 2B made of ceramic, and the conductive portion 3B having conductivity. Similarly to the first embodiment, the contact 1B is disposed on the wiring substrate 20a of the probe card 20, and a bump of a semiconductor device as an object to be tested is disposed in a position that faces a convex direction of the contact 1B. In the case of a conduction test of a semiconductor device, the contact 1B is exposed under an atmosphere of a high temperature and a high voltage in a state where it has been pushed down on the bump.

Here, since the spring portion 2B is made of ceramic similarly to the first embodiment, and is formed in a solid spiral shape, the permanent deformation of the contact 1B can be hard to occur, and an adverse effect of a magnetic field is not exerted on a semiconductor device. Further, since the spring portion 2B is formed by the aerosol deposition method, the spring portion does not need to be sintered, and the wiring substrate 20a is also broken by sintering heat. Moreover, since zirconia-based ceramic, particularly, stabilized zirconia, such as yttria stabilized zirconia or yttria partially-stabilized zirconia is selected as the ceramic, it is possible to obtain the spring portion 2B that is excellent in mechanical property, such as loop deformation property.

Further, as shown in FIG. 5, the conductive portion 3B has the surface-side conductive portion 7B and the back-side conductive portion 8B. The surface-side conductive portion 7B and the back-side conductive portion 8B contact each other, and are connected electrically. From this, since the contact 1B can electrically connect the bump in contact with the surface-side conductive portion 7B and the via hole 20b electrically connected to the back-side conductive portion 8B via the back-side seed film 31, it is possible to form the contact 1B on the surface of the via hole (wiring line) 20b of the wiring substrate 20a. Accordingly, the disposition pitch of contacts 1B to be disposed on the probe card 20 can be made small.

Also, since the surface-side conductive portion 7B is formed using Ni—P, it is possible to improve the wear resistance of the surface-side conductive portion 7B. Further, since the back-side conductive portion 8B is formed using Cu, it is possible to improve the conductivity of the back-side conductive portion 8B more than the surface-side conductive portion 7B made of Ni—P. Accordingly, the conductivity of the whole conductive portion 3B can be improved. In addition, similarly to the first embodiment, since the film thickness of the surface-side conductive portion 7B can be made smaller than the film thickness of the spring portion 2B, the adverse effect of the magnetic field from the surface-side conductive portion 7B on a semiconductor device can be minimized.

Such a contact 1B of the second embodiment is formed through Steps 2a to 2l. The second embodiment is greatly different from the first embodiment in that the back-side conductive portion 8B is formed in Step 2d, as shown in FIG. 6D. Accordingly, as shown in FIG. 6E, when the spring portion 2B made of ceramic is formed in Step 2e, the back-side conductive portion 8B can be disposed at the back 2Bb of the spring portion.

Further, in Step i, as shown in FIG. 6I, the surface-side seed film 30 is formed by a sputter so as to contact and be electrically connected with the back-side seed film 31. Therefore, the surface-side conductive portion 7B that is formed by plating on the surface of the surface-side seed film 31 can be electrically connected to the back-side conductive portion 8B interposed between the back-side seed film 31 and the spring portion 2B.

Also, since the Cr lower layer of the surface-side seed film 30 that becomes a foundation layer of the surface-side conductive portion 7B has good adhesiveness to the spring portion 2B made of ceramic as shown in FIG. 5, the surface-side conductive portion 7B can be prevented from being peeled off from the surface of the spring portion 2B. Further, since the Cu upper layer of the surface-side seed film 30 has good conductivity, the surface-side conductive portion 7B can be easily formed by plating. Since about the Ti lower layer of the back-side seed film 31 that becomes a foundation layer of the back-side conductive portion 8B has goode adhesiveness to the first resist 11, a back-side seed film having uniform film thickness can be formed on the first resist 11. Further, since the conductivity of the Cu upper layer is excellent, the back-side conductive portion 8B can be easily formed by plating.

In addition, effects relating to the points in Steps 2a to Step 2j that the spring portion 2B is formed by the aerosol deposition method, zirconia-based ceramic, particularly, stabilized zirconia is used for the ceramic, Ni—P is used for the surface-side conductive portion 7B, and Cu is used for the back-side conductive portion 8B are the same as the effects of the contact 1B of the second embodiment as mentioned above.

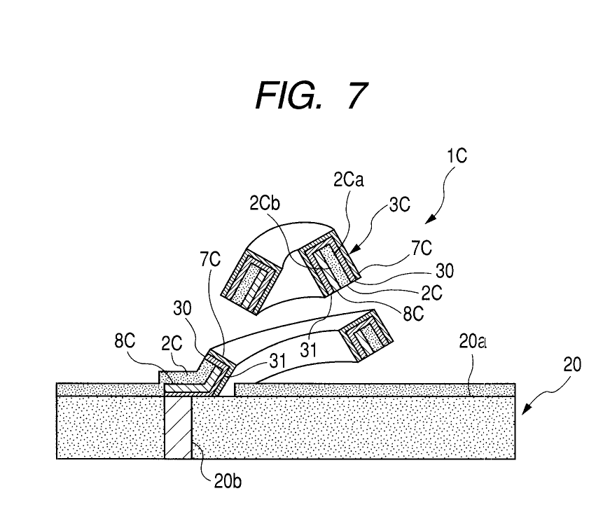

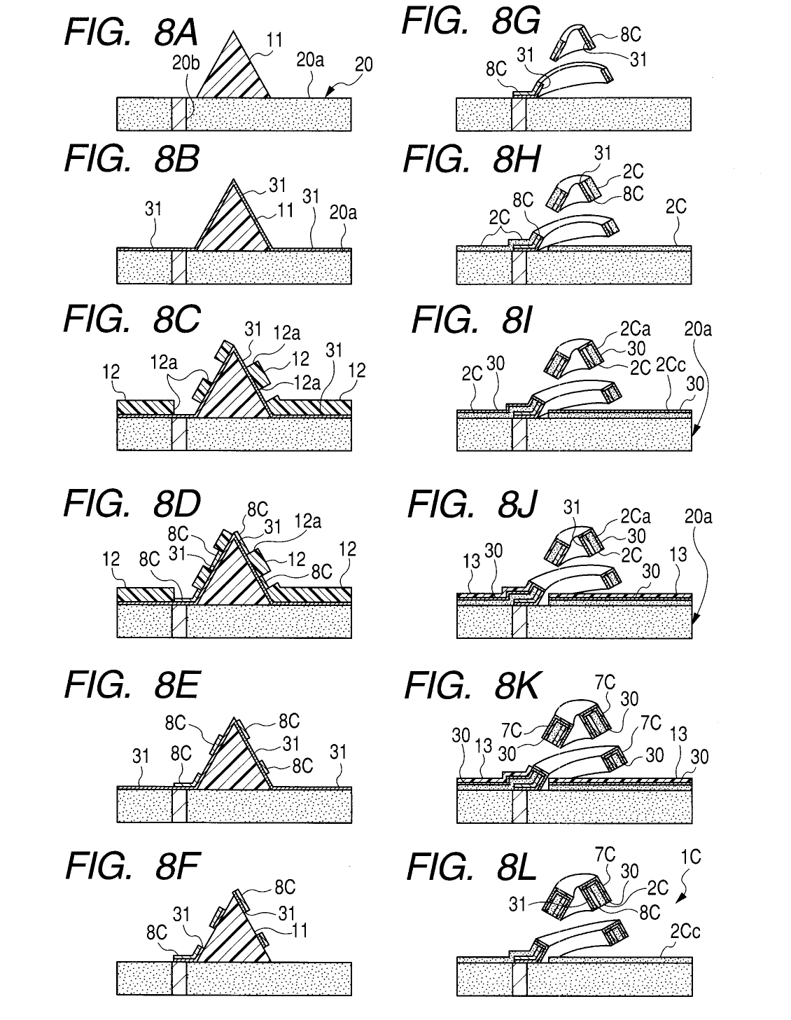

Next, a contact 1C of a third embodiment will be described with reference to FIG. 7. Here, FIG. 7 is a longitudinal sectional view showing the contact 1C of the third embodiment. In addition, description about points that are common to the first embodiment or second embodiment will be omitted or made simply.

As shown in FIG. 7, the contact 1C of the third embodiment includes a spring portion 2C and a conductive portion 3C.

The spring portion 2C is formed on the surface of the wiring substrate 20a of the probe card 20, using ceramic. The third embodiment is different from the first embodiment and second embodiment in that the spring portion 2C is formed by sputtering and sintering ceramic. As the ceramic, zirconia-based ceramic, particularly, stabilized zirconia is selected. This point is the same as that of the first embodiment and second embodiment.

The conductive portion 3C has a surface-side conductive portion 7C that covers a surface 2Ca of the spring portion 2C that faces the bump, and a back-side conductive portion 8C that covers a back 2Cb. Further, the surface-side conductive portion 7C and the back-side conductive portion 8C are electrically connected as they are formed so as to contact each other. The conductive portion 3C is the same as that of the second embodiment.

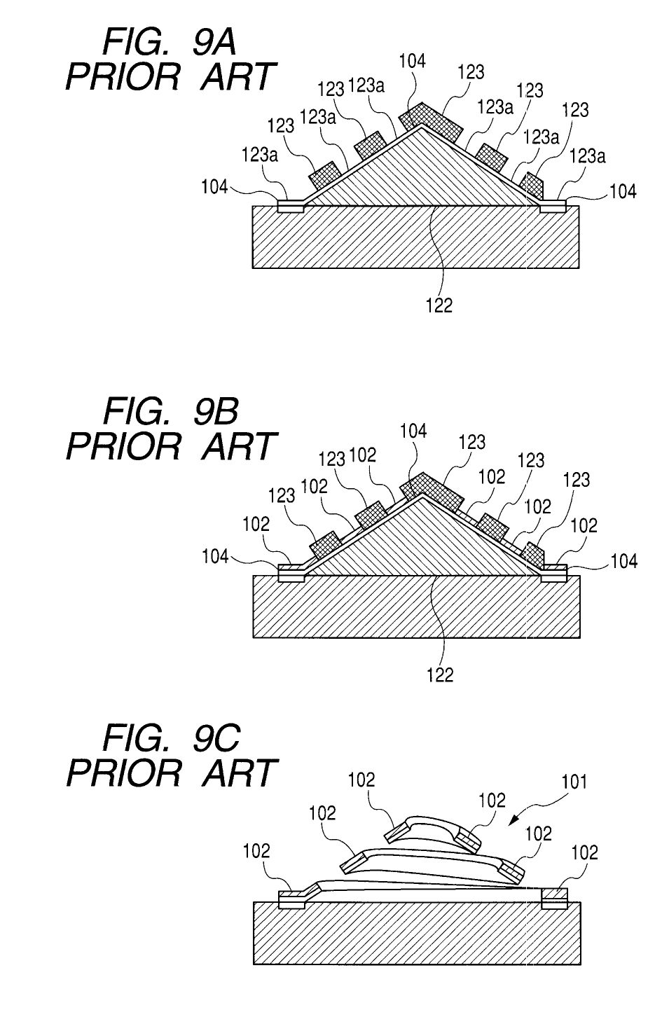

Next, a manufacturing method of the contact 1C of the third embodiment will be described with reference to FIG. 8. Here, FIG. 8 is a longitudinal sectional view showing the manufacturing method of the contact 1C of the third embodiment in order of A to L. In addition, description about points that are common to the first embodiment will be omitted or made simply.

The contact 1C of the third embodiment is manufactured through Steps 3a to 3j.

In Step 3a, as shown in FIG. 8A, the first resist 11 is formed in a conical shape on the surface of the wiring substrate 20a of the probe card 20. This Step 3a is the same as Step 1a of the first embodiment, and the dimensions and resist material of the first resist 11 are also the same as those of the first embodiment.

In Step 3b, as shown in FIG. 8B, the back-side seed film 31 is formed on the surface of the first resist 11 and the surface of the wiring substrate 20a. The back-side seed film 31 is obtained by forming a Cu layer (not shown) having a film thickness of 100 nm on the surface of a Ti layer by sputtering after the Ti layer (not shown) having a film thickness of 15 nm is formed by sputtering on the surface of the first resist 11 and the surface of the wiring substrate 20a.

In Step 3c, as shown in FIG. 8C, the second resist 12 is formed in the shape of a film on the surface of the back-side seed film 31, and the solid spiral groove 12a is patterned in the second resist 12. This Step 3c is the same as Step 1b of the first embodiment, and the resist material of the second resist 12 is also the same as that of the first embodiment.

In Step 3d, as shown in FIG. 8D, the back-side conductive portion 8C is formed by plating on the surface of the back-side seed film 31 exposed by the patterning of the second resist 12. Although the conductive material used for the back-side conductive portion 8C mainly includes metals, such as Cu, Au, and Ni—P, Cu is used fro the back-side conductive portion 8C of the third embodiment. The film thickness of the back-side conductive portion 8C is 5 μm.

In Step 3e, as shown in FIG. 8E, the second resist 12 is removed by a resist remover after the formation of the back-side conductive portion 8C. Then, as shown in FIG. 8F, the back-side seed film 31 exposed by the removal of the second resist 12 is removed by ion milling. After the removal of the back-side seed film 31, as shown in FIG. 8G, the first resist 11 is removed by a resist remover. The resist remover of the first resist 11 and the second resist 12 and the ion milling are the same as those of the first embodiment.

In Step 3f, as shown in FIG. 8H, the spring portion 2C made of ceramic is formed on the surface of the back-side conductive portion 8C by jetting ceramic onto the surface of the back-side conductive portion 8C exposed by the removal of the second resist 12 to form a film. The spring portion 2C of the third embodiment is formed by a ceramic sputtering method, unlike the first embodiment and the second embodiment. Specifically, the spring portion 2C is formed by sputtering ceramic particulates onto the surface of the back-side conductive portion 8C so that the film thickness may become about 10 μm under an atmosphere of a mixed gas consisting of Ar 80% and O₂ 20% and having a pressure of 0.7 Pa, and by sintering the ceramic over 6 hours at 700° C. As the ceramic used for the spring portion 2C, zirconia-based ceramic, particularly, stabilized zirconia, such as yttria stabilized zirconia or yttria partially-stabilized zirconia, is selected. Further, since the sintering of the spring portion 2C is made under an atmosphere of a high temperature, it is preferable to use a heat-resisting material, for example, ceramic, for the wiring substrate 20a.

In Step 3g, as shown in FIG. 8I, the surface-side seed film 30 is formed by sputtering on the surface of a ceramic layer 2 Cc formed on the surface 2Ca of the spring portion 2C and the surface the wiring substrate 20a after the formation of the spring portion 2C. Thereafter, in order to electrically connect the surface-side conductive portion 7C to be formed in the subsequent Step 3i to the back-side conductive portion 8C, the surface-side seed film 30 is formed by sputtering so as to contact the back-side conductive portion 8C. Specifically, similarly to the second embodiment, the surface-side seed film 30 is formed by raising the gas pressure of a sputter so that the surface-side seed film 30 may go round to the back-side seed film 31 from the surface 2Ca of the spring portion 2C. The surface-side seed film 30 is obtained by forming a Cu layer (not shown) having a film thickness of 100 nm on the surface of a Cr layer by sputtering after the Cr layer (not shown) having a film thickness of 15 nm is formed by sputtering on the surface 2Ca of the spring portion 2C, and the surface of the ceramic layer 2 Cc.

In Step 3h, as shown in FIG. 8J, the third resist 13 is formed in the shape of a film only on the surface-side seed film 30 formed on the surface of the wiring substrate 20a. The resist material of the third resist 13 is the same as the resist material of the first resist 11 and the second resist 12. Further, similarly to the second embodiment, the third resist 13 may be formed in a portion of a root of the spring portion 2C.

In Step 3i, as shown in FIG. 8K, the surface-side conductive portion 7C is formed by plating on the surface of the surface-side seed film 30 formed on the surface 2Ca of the spring portion 2C after the formation of the third resist 13. Although the conductive material used for the surface-side conductive portion 7C mainly includes metals, such as Cu, Au, and Ni—P, Ni—P is selected in the surface-side conductive portion 7C of the third embodiment, and the film thickness of the surface-side conductive portion is 2 μm.

In Step 3j, as shown in FIG. 8L, the third resist 13 is removed by a resist remover after the formation of the surface-side conductive portion 7C. Further, after the removal of the third resist 13, the surface-side seed film 30 exposed by the removal of the third resist 13 is removed by ion milling. The resist remover of the third resist 13 is the same as that used for the first resist 11 and the second resist 12.

The contact 1C of the third embodiment is manufactured through the above steps. In addition, similarly to the first embodiment or second embodiment, an Au protective film may be formed on the surface of the conductive portion 3C in order to improve oxidation resistance.

Next, the effects of the contact 1C of the third embodiment and its manufacturing method will be described with reference to FIGS. 7 and 8. In addition, description about points that are common to the first embodiment or second embodiment will be omitted or made simply.

As shown in FIG. 7, the contact 1C of the third embodiment includes the spring portion 2C made of ceramic, and the conductive portion 3C having conductivity. Similarly to the first embodiment and second embodiment, the contact 1C is disposed on the wiring substrate 20a of the probe card 20, and a bump of a semiconductor device as an object to be tested is disposed in a position that faces a convex direction of the contact 1C. In the case of a conduction test of a semiconductor device, the contact 1C is exposed under an atmosphere of a high temperature and a high voltage in a state where it has been pushed down on the bump.

Here, since the spring portion 2C is made of ceramic similarly to the first embodiment and second embodiment, and is formed in a solid spiral shape, the permanent deformation of the contact 1C can be hard to occur, and an adverse effect of a magnetic field is not exerted on a semiconductor device. However, unlike the first embodiment and second embodiment, the spring portion 2C is formed by sputtering and sintering. Thus, the contact 1C of the third embodiment is formed on the surface of the wiring substrate 20a using a heat-resisting material, such as ceramic. Moreover, since zirconia-based ceramic, particularly, stabilized zirconia, such as yttria stabilized zirconia or yttria partially-stabilized zirconia is selected as the ceramic used for the spring portion 2C similarly to the first embodiment and second embodiment, it is possible to obtain the spring portion 2C that is excellent in mechanical property, such as loop deformation property.

Further, the contact 1C includes the conductive portion 3C, and similarly to the second embodiment, the conductive portion 3C has the surface-side conductive portion 7C and the back-side conductive portion 8C. The surface-side conductive portion 7C is formed on the surface 2Ca of the spring portion 2C, and the back-side conductive portion 8C is formed on the back 2Cb of the spring portion 2C. Also, the surface-side conductive portion 7C and the back-side conductive portion 8C are electrically connected via the back-side seed film 31. From this, since the contact 1C can electrically connect the bump in contact with the surface-side conductive portion 7C and the via hole 20b electrically connected to the back-side conductive portion 8C via the back-side seed film 31, it is possible to form the contact 1C on the surface of a wiring line of the wiring substrate 20a. Accordingly, the disposition pitch of contacts 1C to be disposed on the probe card 20 can be made small.

Also, since the surface-side conductive portion 7C is formed using Ni—P, it is excellent in wear resistance, and since the back-side conductive portion 8C is formed using Cu, it is excellent in conductivity.

Such a contact 1C of the third embodiment is formed through Steps 3a to 3j, as shown in FIG. 8. The third embodiment is greatly different from the first embodiment and second embodiment in that the spring portion 2C is formed by sputtering and sintering in Step 3f, as shown in FIG. 8H. Therefore, as shown in FIGS. 8E and 8G, the first resist 11 and the second resist 12 that do not have thermal resistance are removed till Step 3e before Step 3f. Accordingly, even not at room temperature, the spring portion 2C made of ceramic can be formed. Therefore, the contact 1C that permanent deformation is hard to occur can be manufactured. Further, as shown in FIG. 8D, the back-side conductive portion 8C is formed in advance in Step 3d so that the back-side conductive portion 8C may be disposed at the back 2Cb of the spring portion 2C. Thus, even if the spring portion 2C is formed on the surface of a wiring line of the wiring substrate 20a, a bump in contact with the contact 1C can be electrically connected to the wiring line.

In addition, effects relating to the points in Steps 3a to Step 3j that zirconia-based ceramic, particularly, stabilized zirconia is used for the ceramic, Ni—P is used for the surface-side conductive portion 7C, Cu is used for the back-side conductive portion 8C, a Ti/Cu laminated metal is used for the surface-side seed film 30, and a Cr/Cu laminated metal is used for the back-side seed film 31 are the same as the effects of the contact 1B of the second embodiment and its manufacturing method as mentioned above.

That is, according to the contacts 1A to 1C of the first to third embodiments and their manufacturing methods, mechanical property is improved by making the spring portions 2A to 2C of ceramic with no magnetism. Thus, the contacts can be prevented from yielding even if a conduction test of a semiconductor device is repeatedly performed, and it is possible to suppress that an adverse effect of a magnetic field is exerted on the semiconductor device.

Further, according to the contacts 1A and 1B of the first to second embodiments and their manufacturing methods, the spring portions 2A and 2B made of ceramic can be formed at room temperature. Thus, a conventionally used wiring substrate 20a can be utilized without the change thereof.

In addition, the invention is not limited to the aforementioned embodiment or the like, and various changes thereof can be made if necessary. For example, in the third embodiment, the spring portion 3B may be formed by the aerosol deposition method.

1. A contact comprising:
a spring portion formed using ceramic on the surface of a wiring substrate of a probe card; and
a conductive portion formed using a conductive material so as to cover at least the surface of the spring portion that faces a bump, and connected to a wiring line formed on the wiring substrate.

2. The contact according to claim 1,
wherein the spring portion is formed in a solid spiral shape that protrudes toward the bump.

3. The contact according to claim 1,
wherein the spring portion is formed by an aerosol deposition method.

4. The contact according to claim 1,
wherein the ceramic is zirconia-based ceramic.

5. The contact according to claim 4,
wherein the zirconia-based ceramic is yttria stabilized zirconia or yttria partially-stabilized zirconia.

6. The contact according to claim 1,
wherein the conductive portion is formed by plating using Ni—P, or Cu/Ni—P laminated metal in which Ni—P is laminated on Cu, at the surface of the spring portion.

7. The contact according to claim 6,
wherein the conductive portion is formed on the surface of the spring portion that has on its surface a seed film with a Cr/Cu laminated structure that uses Cr for a lower layer and uses Cu for an upper layer.

8. The contact according to claim 6,
wherein the conductive portion is electrically connected from the surface side of the spring portion, and is formed at the back of the spring portion using Cu.

9. The contact according to claim 1,
wherein the conductive portion has a protective film, which is formed using Au, on the surface of the conductive portion.

10. A manufacturing method of a contact comprising:
a step 1a of forming a first resist in a conical shape on the surface of a wiring substrate of a probe card;
a step 1b of forming a second resist in the shape of a film on the surface of the conical first resist, and patterning a solid spiral groove in the second resist;
a step 1c of jetting ceramic onto the conical first resist that has the second resist on its surface to form a film, and thereby forming a spring portion made of ceramic inside the groove formed in the second resist;
a step 1d of removing the second resist and the first resist after the formation of the spring portion;
a step 1e of forming a seed film on the surface of the spring portion and the surface of the wiring substrate by sputtering after the removal of the second resist and the first resist;
a step if of forming a third resist in the shape of a film on the surface of the seed film and the surface of the wiring substrate, and performing on the third resist the patterning of exposing the seed film formed on the surface of the spring portion and on the surface of the wiring substrate from the spring portion to a wiring line formed on the wiring substrate;
a step 1g of forming a conductive portion by plating on the surface of the seed film exposed from the third resist; and
a step 1h of removing the third resist after the formation of the conductive portion, and removing the seed film exposed by the removal of the third resist.

11. A manufacturing method of a contact comprising:
a step 2a of forming a first resist in a conical shape on the surface of a wiring substrate of a probe card;
a step 2b of forming a back-side seed film by sputtering on the surface of the first resist and the surface of the wiring substrate;
a step 2c of forming a second resist in the shape of a film on the surface of the back-side seed film, and patterning a solid spiral groove in the second resist;
a step 2d of forming a back-side conductive portion in the shape of a film on the back-side seed film exposed from the groove of the second resist;
a step 2e of jetting ceramic onto the surface of the back-side conductive portion and the surface of the second resist to form a film, and thereby forming a spring portion made of ceramic on the surface of the back-side conductive portion exposed from the groove of the second resist;
a step 2f of removing the second resist after the formation of the spring portion;
a step 2g of removing the back-side seed film exposed by the removal of the second resist;
a step 2h of removing the first resist after the removal of the back-side seed film;
a step 2i of forming a surface-side seed film by sputtering on the surface of the spring portion and the surface of the wiring substrate so as to be electrically connected to the back-side seed film formed at the back of the back-side conductive portion after the removal of the first resist;
a step 2j of forming a third resist in the shape of a film on the surface-side seed film formed on the surface of the wiring substrate;
a step 2k of forming a surface-side conductive portion on the surface-side seed film exposed after the formation of the third resist; and a step 2l of removing the third resist after the formation of the surface-side conductive portion, and removing the surface-side seed film exposed by the removal of the third resist.

12. A manufacturing method of a contact comprising:
a step 3a of forming a first resist in a conical shape on the surface of a wiring substrate of a probe card;
a step 3b of forming a back-side seed film by sputtering on the surface of the first resist and the surface of the wiring substrate;
a step 3c of forming a second resist in the shape of a film on the surface of the back-side seed film, and patterning a solid spiral groove in the second resist;
a step 3d of forming a back-side conductive portion in the shape of a film on the back-side seed film exposed from the groove of the second resist;
a step 3e of removing the second resist after the formation of the back-side conductive portion, removing the back-side seed film exposed by the removal of the second resist, and removing the first resist after the removal of the back-side seed film;
a step 3f of jetting ceramic onto the surface of the back-side conductive portion exposed by the removal of the second resist to form a film, and thereby forming a spring portion made of ceramic on the surface of the back-side conductive portion;
a step 3g of forming a surface-side seed film by sputtering on the surface of the spring portion and the surface of the wiring substrate so as to be electrically connected to the back-side seed film formed at the back of the back-side conductive portion after the removal of the spring portion;
a step 3h of forming a third resist in the shape of a film on the surface-side seed film formed on the surface of the wiring substrate;
a step 3i of forming a surface-side conductive portion on the surface-side seed film formed on the surface of the spring portion, after the formation of the third resist; and
a step 3j of removing the third resist after the formation of the surface-side conductive portion, and removing the surface-side seed film exposed by the removal of the third resist.

13. The manufacturing method of contact according to claim 10,
wherein the spring portion is formed by the aerosol deposition method.

14. The manufacturing method of contact according to claim 10,
wherein the ceramic is zirconia-based ceramic.

15. The manufacturing method of a contact according to claim 14,
wherein the zirconia-based ceramic is yttria stabilized zirconia or yttria partially-stabilized zirconia.

16. The manufacturing method of a contact according to claim 10,
wherein the conductive portion or surface-side conductive portion is formed by plating using Ni—P, or Cu/Ni—P laminated metal in which Ni—P is laminated on Cu.

17. The manufacturing method of contact according to claim 10,
wherein the back-side conductive portion is formed by plating using Cu.

18. The manufacturing method of contact according to claim 10,
wherein the seed film or surface-side seed film is formed as a Cr/Cu laminated structure that uses Cr for a lower layer and uses Cu for an upper layer.

19. The manufacturing method of contact according to claim 10,
wherein the back-side seed film is formed as a Ti/Cu laminated structure that uses Ti for a lower layer and uses Cu for an upper layer.

20. The manufacturing method of a contact according to claim 10,
wherein the conductive portion or surface-side conductive portion has a protective film that is formed using Au on the surface thereof.
